(19) United States
(12) Patent Application Publication
(10) Pub. No.: US 2026/0099008 A1
(43) Pub. Date: Apr. 9, 2026

(54) LASER PROCESSING HEADS AND SYSTEMS FOR CONNECTING FIBER OPTIC CABLE TO OPTICS

(71) Applicant: II-VI Delaware, Inc., Wilmington, DE (US)

(72) Inventor: Rolf-Friedrich FINCK, Kleinmachnow (DE)

(21) Appl. No.: 18/909,324

(22) Filed: Oct. 8, 2024

(51) Int. Cl. G02B 6/36; B23K 26/064

(52) U.S. Cl. CPC G02B 6/3624; B23K 26/064

(57) ABSTRACT

Laser processing heads and systems are disclosed. The system includes optics configured to receive a laser beam and a connector configured to connect to an upstream end of the optics and configured to optically communicate the laser beam from a fiber optic cable to the optics. The system also includes a seal configured to sit within a recess between the upstream end of the optics and a downstream end of the connector. The connector and the optics, when the connector is connected to the optics, maintain separation between the connector and the optics radially inwardly of the seal.

### BACKGROUND

Laser processing heads can utilize a high-power laser to melt materials, which can produce precise and clean cuts, among other applications. Laser processing heads can be employed with various types of lasers, such as CO₂ lasers, neodymium lasers, neodymium yttrium-aluminum-garnet lasers, among other possibilities. Different types of lasers can be suited for different applications like cutting, welding, boring, engraving, among other possibilities.

Laser cutting can offer several advantages over traditional mechanical cutting. For example, laser cutting can reduce contamination since there is no physical cutting edge that can wear out or become contaminated. Laser cutting also can minimize the risk of warping the workpiece, since the heat-affected zone is relatively small. Additionally, laser cutting can be more precise and energy-efficient compared to other cutting techniques, especially for sheet metal.

### BRIEF SUMMARY

In current laser processing heads, a fiber optic cable delivers the laser light to optics for focusing the laser beam for various applications, such as for example cutting. The fiber optic cable is typically connected to the optics via one or more connectors. However, existing connectors do not adequately manage direct interfaces between the connectors and the optics, which can create debris or other contaminants that can degrade the optics.

This issue is addressed, at least in part, by laser processing heads and systems in accordance with aspects of this disclosure. In one aspect, a system includes optics configured to receive a laser beam and a connector configured to connect to an upstream end of the optics and configured to optically communicate the laser beam from a fiber optic cable to the optics. The system also includes a seal configured to sit within a recess between the upstream end of the optics and a downstream end of the connector. A portion of the connector and a portion of the optics are configured, when the connector is connected to the optics, to maintain separation between the connector and the optics radially inwardly of the seal.

Implementations may include one or more of the following features. The optics define an interior, and the portion of the connector and the portion of the optics are configured, when the connector is connected to the optics, to define a gap throughout a three dimensional region between the connector and the optics from the seal to the interior of the optics and to prevent any direct contact between the connector and the optics. The upstream end of the optics may include a seat that the seal is configured to sit within. The downstream end of the connector may include an inner face and a projection that projects downstream beyond the inner face, and the recess is defined by the seat, the inner face, and the projection. The upstream end of the optics may include an inner face, the seat is recessed downstream from the inner face of the upstream end of the optics, and the portion of the connector and the portion of the optics are configured, when the connector is connected to the optics, to prevent direct contact between the inner face of the connector and the inner face of the optics. The upstream end of the optics may include a flange projecting upstream, and the flange is configured, when the connector is connected to the optics, to align a center of an interior of the connector with a center of an interior of the optics. The downstream end of the connector may include a flange projecting radially outwardly, the portion of the optics may include the flange of the upstream end of the optics, the portion of the connector may include the flange of the downstream end of the connector, and the flange of the downstream end of the connector and the flange of the upstream end of the optics are configured, when the connector is connected to the optics, to abut against each other to maintain separation between the connector and the optics radially inwardly of the seal. The downstream end of the connector may include a projection that projects downstream, the upstream end of the optics may include a seat, and the seat is configured, when the connector is connected to the optics, to receive the projection. The portion of the optics may include the seat, the portion of the connector may include the projection, and the projection and the seat are configured such that, when the connector is connected to the optics, the projection sits within the seat and maintains separation between the connector and the optics radially inwardly from the seal. The upstream end of the optics may include a flange projecting upstream, the downstream end of the connector may include a flange projecting radially outwardly, the portion of the optics further may include the flange of the upstream end of the optics, the portion of the connector further may include the flange of the downstream end of the connector, and the flange of the downstream end of the connector and the flange of the upstream end of the optics are configured, when the connector is connected to the optics, to abut against each other to maintain separation between the connector and the optics radially inwardly of the seal. The flange of the upstream end of the optics, the flange of the downstream end of the connector, the seat, and the projection can be radially outward of the seal when the seal is within the recess. The connector is a first connector and the system further may include a second connector. The second connector is connected to the fiber optic cable, and the first connector is configured to receive the second connector within an interior of the first connector. The seal is a first seal and the system further may include a second seal within the interior of the first connector. An outer surface of the second connector is configured, when the second connector is received within the interior of the first connector, to directly contact an inner surface of the first connector to define an interface, and the second seal is downstream from the interface. The second seal, when the first seal is within the recess, is upstream from the first seal. The connector is directly connected to the fiber optic cable.

Another general aspect includes a laser processing head. The laser processing head includes a laser configured to generate a laser beam. The head also includes a fiber optic cable in optical communication with the laser. The head also includes a connector in optical communication with the fiber optic cable. The head also includes optics in optical communication with the connector and connected to a downstream end of the connector. The optics are configured to receive the laser beam. The head also includes a seal configured to sit within a recess between an upstream end of the optics and the downstream end of the connector. A portion of the connector and a portion of the optics are configured, when the connector is connected to the optics, to maintain separation between the connector and the optics radially inwardly of the seal.

Implementations may include one or more of the following features. The optics define an interior, and the portion of the connector and the portion of the optics are configured, when the connector is connected to the optics, to define a gap throughout a three dimensional region between the connector and the optics from the seal to the interior of the optics and to prevent any direct contact between the connector and the optics. The portion of the optics may include a flange at the upstream end of the optics, the portion of the connector may include a flange at the downstream end of the connector, and the flange of the downstream end of the connector and the flange of the upstream end of the optics are configured, when the connector is connected to the optics, to abut against each other to maintain separation between the connector and the optics radially inwardly of the seal. The portion of the connector may include a projection at the downstream end of the connector, the portion of the optics may include a seat at the upstream end of the optics, and the seat and the projection are configured, when the connector is connected to the optics, such that the projection sits within the seat and maintains separation between the connector and the optics radially inwardly from the seal.

Various additional features and advantages of this invention will become apparent to those of ordinary skill in the art upon review of the following detailed description of the illustrative embodiments taken in conjunction with the accompanying drawings.

### BRIEF DESCRIPTION OF THE SEVERAL VIEWS OF THE DRAWINGS

The following detailed description is better understood when read in conjunction with the appended drawings. For the purposes of illustration, examples are shown in the drawings; however, the subject matter is not limited to the specific elements and instrumentalities disclosed. In the drawings:

FIG. 1 illustrates a schematic, cross section view of a known system for connecting a fiber optic cable with optics.

FIG. 2A illustrates a schematic, cross section view of a first embodiment of a system for connecting a fiber optic cable with optics according to aspects of this disclosure.

FIG. 2B illustrates a magnified view of the first embodiment of the system within region A of FIG. 2A.

FIG. 3 illustrates a schematic, cross section view of a rolling seal according to aspects of this disclosure.

FIG. 4A illustrates a schematic, cross section view of a second embodiment of a system for connecting a fiber optic cable with optics according to aspects of this disclosure.

FIG. 4B illustrates a magnified view of the second embodiment of the system within region A of FIG. 4A.

FIG. 5 illustrates a schematic view of a laser processing head according to aspects of this disclosure.

### DETAILED DESCRIPTION

Laser cutting can involve directing a laser beam through optics and manipulating the focused laser beam to follow specific cutting patterns. The focused laser beam can melt, burn, or vaporizes the workpiece, leaving clean edges and a high-quality surface finish. The environment surrounding laser processing heads can be filled with debris or other contaminants resulting from cutting the workpiece. Such debris or other contaminants can damage or impede the effectiveness of the optics, particularly if the debris or other contaminants reach the interior of the optics. For example, if the debris or other contaminants are deposited on a lens of the optics, the laser beam can burn the debris or other contaminants on the lens, which can result in permanent damage or degradation of the lens. Moreover, some laser processing heads include various structures (e.g., gantries, motors, etc.) capable of rapidly accelerating the optics over the workpiece during the cutting procedure. Such rapid accelerations can subject the optics, and structures connected thereto, to significant forces (e.g., 6 Gs). Rapid acceleration can cause contact abrasion or fretting between various structures of the laser processing head, which can be a source of debris or other contaminants that can damage or degrade the optics. Another disadvantage of exposing debris or other contaminants to the optics is that it can require down time of the laser processing head for cleaning.

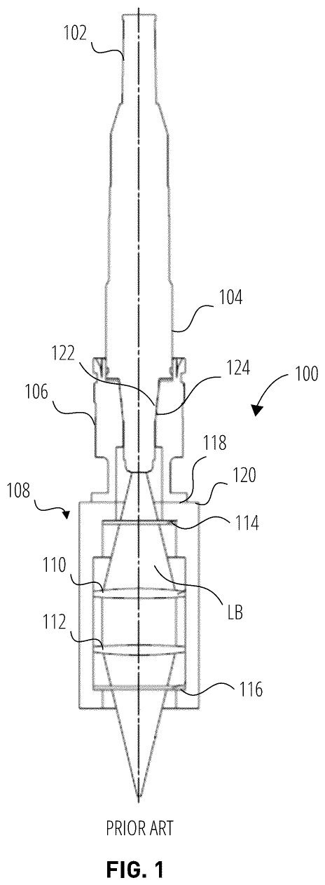

FIG. 1 shows a cross-section schematic view of a known system 100 for connecting a fiber optic cable 102 to optics 108 of a laser processing head. While the embodiments are described in the context of connected to a fiber optic cable to the optics of a laser processing head because certain conditions common to laser cutting gantries, the disclosure is not so limiting and may be applied to other fiber optic connections, in particular in other applications where it desired to reduce debris or other contaminants or reduce abrasion or wear. The system 100 can include a laser receiver 106 that can receive a laser connector 104 of a downstream end of the fiber optic cable 102, which carries laser light from a laser (not shown) downstream to the laser connector 104. The laser receiver 106 can connect the laser connector 104 to optics 108 of the laser processing head. The optics 108 can include any number of different structures for focusing a laser beam LB emitted from the fiber optic cable 102, for connecting the optics 108 to other structures, for protecting the optics 108, for collimating, for combining the laser beam LB, for splitting the laser beam LB, for shaping the laser beam LB, or for other purposes. For example, the optics 108 can include one or more lenses, such as a first lens 110 and a second lens 112, for focusing the laser beam LB. The optics 108 can include one or more shields, such as an upstream shield 114 and a downstream shield 116, for shielding the environment from debris or other contaminants.

The system 100 can make the optics 108 vulnerable to debris or other contaminants that can cause damage or degradation. For example, an outer surface 122 of the laser connector 104 can directly interface with an inner surface 124 of the laser receiver 106. This direct interface can cause contact abrasion and/or fretting when the system 100, for example, is moved at high accelerations during cutting procedures and/or when the laser connector 104 is connected to the laser receiver 106. The contact abrasion and/or fretting can be particularly problematic when both the outer surface 122 and the inner surface 124 are formed of metal materials, but abrasion can also be problematic due to contact between non-metal materials.

The structural interface between the laser receiver 106 and the optics 108 of the known system 100 can also expose the optics 108 to debris or other contaminants that can cause damage or degradation. For example, a downstream end 118 of the laser receiver 106 can be a planar face that can directly interface with a planar face of an upstream end 120 of the optics 108. But debris or other contaminants can pass through this interface and into the interior of the optics 108. This direct interface can also cause contact abrasion and/or fretting when the system 100, such as when the system 100 is moved at high accelerations during cutting procedures. The contact abrasion and/or fretting can be particularly problematic when both the downstream end 118 and the upstream end 120 are formed of metal materials, but again abrasion can also be problematic due to contact between non-metal materials.

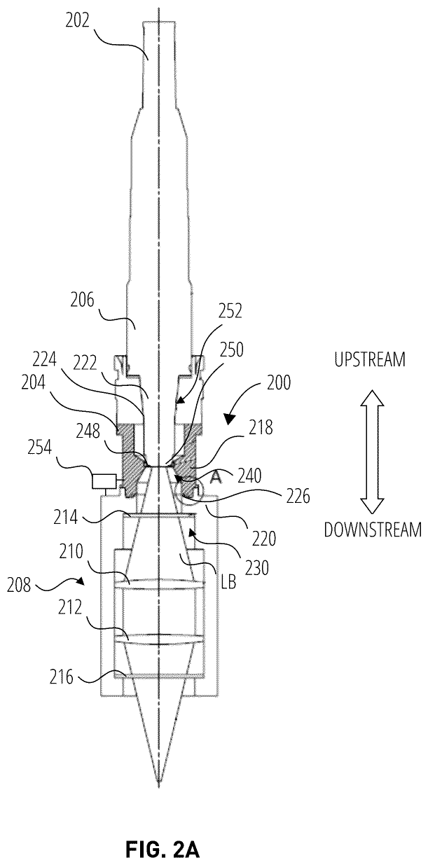

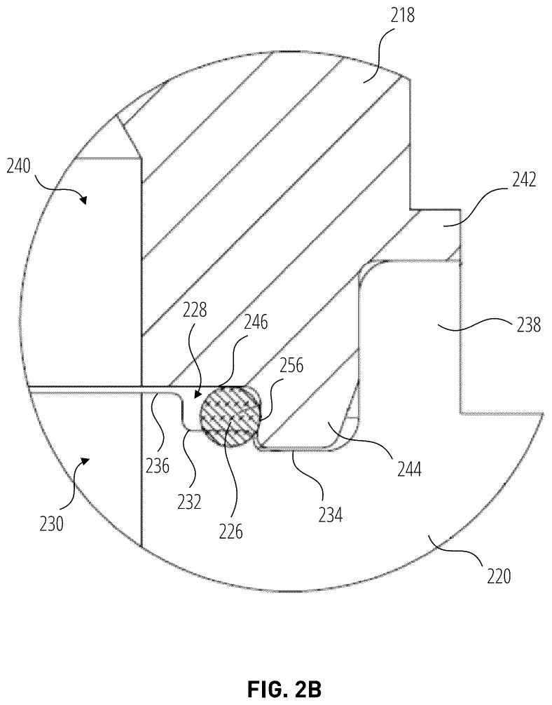

Aspects of this disclosure are directed to systems for connecting a fiber optic cable to optics of a laser processing head. The systems can include a number of features that can protect the optics from debris or other contaminants and/or that reduce the incidence of contact abrasion and/or fretting that cause the formation of such debris or other contaminants. For example, the systems can prevent direct contact between a connector and the optics radially inward from a seal to reduce or eliminate opportunities for contact abrasion and/or fretting and thereby protect the optics from debris or other contaminants. These and other aspects of the disclosure are described in further detail as follows and as shown in FIG. 2A-5.

FIG. 2A shows a cross section schematic view of a system 200 for connecting a fiber optic cable 202 and focusing a laser beam LB received from the fiber optic cable 202 in accordance with some aspects of this disclosure.

FIG. 2B shows a magnified view of the system 200 within region A of FIG. 2A. The system 200 can include optics 208 that can focus a laser beam LB emitted from a laser of a laser processing head. The optics 208 can include any of the features, structures, relationships, etc., described previously with respect to the optics 108 including for example a first lens 210, a second lens 212, an upstream shield 214, and a downstream shield 216. The terms “upstream” and “downstream” as used herein refer to locations relative to the emission direction of the laser beam LB, as would be readily appreciated by persons of skill in the art. The system 200 can further include a connector, such as for example a first connector 204. The terms “first,” “second,” etc., can be used as a naming convention in this disclosure without limiting the disclosure to any particular number of structures. For example, the term “second” can mean that there are two or more structures of the same name, but in alternative embodiments there can be only a single structure even when that structure is named a “second” structure. Put differently, the term “second” can encompass embodiments with at least two structures, but does not limit the disclosure to multiple structures.

The first connector 204 can connect to an upstream end 220 of the optics 208 and can optically connect a fiber optic cable 202 of the laser processing head with the optics 208. For example, the first connector 204 can include an interior 240 that defines an optical pathway through the first connector 204 and to the optics 208. The system 200 can also include a seal, such as for example a first seal 226. The first seal 226 can occupy a recess 228 between the upstream end 220 of the optics 208 and a downstream end 218 of the first connector 204. In embodiments, the first seal 226 can be compressible and can be compressed within the recess 228 between the downstream end 218 of the first connector 204 and the upstream end 220 of the optics 208.

The first connector 204 and the optics 208 can, when the first connector 204 is connected to the optics 208, define a gap between the first connector 204 and the optics 208 radially inwardly of the first seal 226. Radially inwardly, in this context, can include within a three-dimensional virtual region defined by the first seal 226. The three-dimensional virtual region can be circumferentially bound the first seal 226. The three-dimensional virtual region can extend along an optical axis a of the system 200 from a bottom (or downstream most portion) of the first seal 226 to a top (or upstream most portion) of the first seal 226. In embodiments, the first connector 204 and the optics 208 can, when the first connector 204 is connected to the optics 208, define the gap between the first connector 204 and the optics 208 such that no portion of the first connector 204 directly contacts any portion of the optics 208 radially inwardly of the first seal 226 (e.g., at any point within the three-dimensional virtual region, previously described). Accordingly, the first connector 204 and the optics 208 can be structured and arranged to prevent direct contact between any portion of the first connector 204 and any portion the optics 208 within the three-dimensional virtual region, including from the first seal 226 to an interior 230 of the optics 208. By preventing direct contact between the first connector 204 and the optics 208 within the first seal 226, the incidence of contact abrasion and/or fretting can be reduced or eliminated within the area bounded by the first seal 226. This can protect the optics 208 since the first seal 226 can prevent debris or other contaminants from reaching the optics 208 from locations outside the boundary of the first seal 226 and since direct contact between the first connector 204 and the optics 208 within the boundary of the first seal 226 is prevented by the structure and arrangement of the first connector 204 and the optics 208.

In embodiments, the upstream end 220 of the optics 208 can include a seat, such as for example a first seat 232. The first seat 232 can receive the first seal 226. In embodiments, the first seat 232 can removably receive the first seal 226, which can facilitate cleaning of the system 200. In embodiments, the first seat 232 can, substantially or completely, shield the first seal 226 from scattered light. The upstream end 220 of the optics 208 can further include a second seat 234 arranged radially outward relative to the first seat 232. The upstream end 220 can also include an inner face 236. The inner face 236 can be arranged radially inward of the first seat 232 between the interior 230 and the first seat 232. The first seat 232 and the second seat 234 can each be recessed downstream relative to the inner face 236. In embodiments, the second seat 234 can be recessed downstream relative to the first seat 232. Alternatively, in embodiments not shown the first seat 232 and the second seat 234 can be at the same level or the first seat 232 can be recessed downstream relative to the second seat 234. The first seal 226 can, when seated within the recess 228, extend upstream beyond the inner face 236, which can prevent the debris or other contaminants from passing through the first seal 226 and reaching the inner face 236.

The upstream end 220 can also include a flange 238, which can center the first connector 204 when the first connector 204 connects to the optics 208. That is, the flange 238 can align a center of an interior 240 of the first connector 204 with a center of the interior 230 of the optics 208 to optimize the optical pathway between the first connector 204 and the optics 208. Additionally or alternatively, cylindrical pins or other mechanical elements can used to align a center of an interior 240 of the first connector 204 with a center of the interior 230 of the optics 208 to optimize the optical pathway between the first connector 204 and the optics 208. The flange 238 can be radially outward of the first seal 226, the inner face 236, the first seat 232, and/or the second seat 234. The flange 238 can project upstream, i.e., away from the second seat 234. In embodiments, the flange 238 can project upstream beyond the inner face 236.

The first connector 204 can include a number of features that can be complementary with one or more features of the optics 208 such that, when the first connector 204 is connected to the optics 208, the features can prevent direct contact between the first connector 204 and the optics 208 radially inwardly of the first seal 226, as previously described. For example, the downstream end 218 of the first connector 204 can include a flange 242. The flange 242 can project radially outwardly and can, when the first connector 204 is connected to the optics 208, abut against the flange 238 of the optics 208. In embodiments, the flange 242 of the first connector 204 and the flange 238 of the optics 208 can be structured and arranged such that when the first connector 204 is connected to the optics 208, the flange 242 of the first connector 204 and the flange 238 of the optics 208 can maintain separation between the first connector 204 and the optics 208 radially inward from the first seal 226, as previously described. For example, the flange 242 of the first connector 204 and the flange 238 of the optics 208 can be structured and arranged such that the abutment between the flange 242 of the first connector 204 and the flange 238 of the optics 208 can maintain separation between the first connector 204 and the optics 208 radially inward from the first seal 226, as previously described.

The first connector 204 can also include a projection 244. The projection 244 can project downstream. The projection 244 can be complimentary with the second seat 234. For example, the projection 244 can, when the first connector 204 is connected to the optics 208, sit within the second seat 234. The projection 244 and the second seat 234 can be structured and arranged such that, when the first connector 204 is connected to the optics 208, the projection 244 and the second seat 234 can maintain separation between the first connector 204 and the optics 208 radially inward from the first seal 226, as previously described. For example, the first connector 204 can include an inner face 246. The inner face 246 can extend between the interior 240 of the first connector 204 and the projection 244. The projection 244 can project downstream from the inner face 246. The projection 244 can project downstream from the inner face 246 of the first connector 204 by an amount and the second seat 234 can be recessed downstream from the inner face 236 of the optics 208 by an amount such that, when the first connector 204 and the optics 208 are connected, the projection 244 sits within the second seat 234 and maintains a separation between the inner face 236 of the optics 208 and the inner face 246 of the first connector 204. In embodiments, the recess 228 can be defined by the first seat 232, the inner face 246 of the first connector 204, and the projection 244.

In embodiments, the projection 244 can include a notch 256. The notch 256 can secure the first seal 226 to the first connector 204. According to this configuration, the first seal 226 can remain secured to the first connector 204 when the first connector 204 is separated from the optics 208, which can facilitate cleaning of internal aspects of the optics 208 and/or the first connector 204. In alternative embodiments, the projection 244 can be provided without the notch 256. In some such embodiments, the optics 208 can include a notch (not shown) that can secure the first seal 226 to the optics 208, which can facilitate cleaning of internal aspects of the optics 208 and/or the first connector 204. For example, the optics 208 can include a notch (not shown) cut into the optics 208 between the inner face 236 and the first seat 232.

In embodiments, the fiber optic cable 202 can include a second connector 206 (FIG. 2A) at a downstream end of the fiber optic cable 202. The second connector 206 can connect to the first connector 204 and, when connected, can be in optical communication with the first connector 204. In this manner, the first connector 204 can serve as an adapter for connecting a second connector 206 to the optics 208, which can improve the compatibility of the system 200. The interior 240 of the first connector 204 can be structured and arranged to receive the second connector 206.

The first connector 204 can include a number of features that can reduce or eliminate contact abrasion and/or fretting between the first connector 204 and the second connector 206 and/or that can prevent debris or other contaminants associated with the connection between the first connector 204 and the second connector 206 from reaching the optics 208. For example, the first connector 204 can include a second seal 248 that can receive a downstream end 250 of the second connector 206. In embodiments, the second seal 248 can be interposed between the downstream end 250 of the second connector 206 and all interior surfaces that define the interior 240 of the first connector 204 to prevent direct contact between the downstream end 250 of the second connector 206 and the interior surfaces of the first connector 204 that define the interior 240 of the first connector 204. In embodiments, the second seal 248 can be a ring seal that partially or completely surrounds the downstream end 250 of the second connector 206 when the downstream end 250 of the second connector 206 is connected to the first connector 204. The second seal 248 can be downstream from any direct interface between the first connector 204 and the second connector 206, and as a result, can prevent debris or other contaminants that results from any direct interface between the first connector 204 and the second connector 206. For example, the second connector 206 can include an outer surface 222 and the interior 240 of the first connector 204 can include an inner surface 224. When the second connector 206 is connected to the first connector 204, the outer surface 222 can form a direct interface 252 with the inner surface 224, which can cause contact abrasion, fretting, particle generation, etc. Since the second seal 248 can be downstream from the interface 252, the second seal 248 can prevent debris or other contaminants generated at the interface 252 from reaching the optics 208.

In embodiments, the optics 208 can be provided without the upstream shield 214, which can prevent focal shift that would otherwise result from the presence of the upstream shield 214. The optics 208 can be protected from debris or other contaminants without the upstream shield 214 because of the features of the system 200 described previously that prevent or mitigate generation of debris or other contaminants and/or that prevent debris or other contaminants from reaching the optics 208.

The system 200 can include a fastener 254, shown schematically, that can connect the first connector 204 and the optics 208. The fastener 254 can include, for example, threads, bolts, clamps, combinations thereof, among other possibilities. After assembly of, for example, the fiber optic cable 202, the second connector 206, the interface 252, and the first connector 204, the interior 240 space can be cleaned. This can be accomplished, without disconnecting the fiber optic cable 202 and the second connector 206, by opening the fastener 254 and separating the downstream end 218 from the upstream end 220 to thereby provide access to the interior 240. Since the interior 240 can be accessed without disconnecting the fiber optic cable 202 and the second connector 206, the second seal 248 can prevent dirt and debris upstream from the second seal 248 from falling into the optics 208.

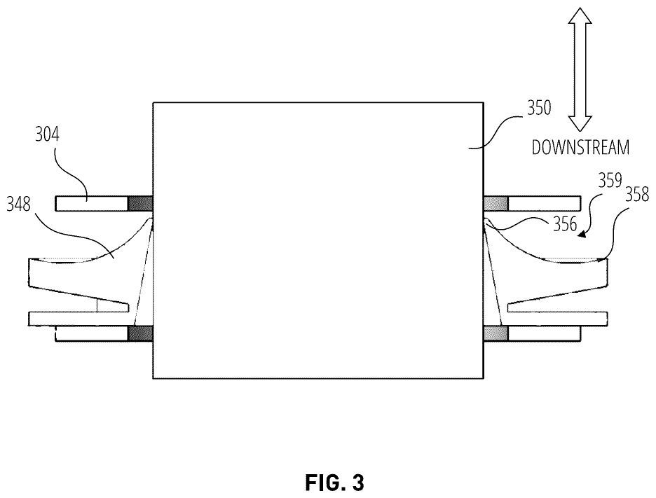

FIG. 3 shows a schematic cross section view of an embodiment of the second seal 348. The second seal 348 can be an aspect of the first connector 304 and can include the features, structures, and relationships described previously with respect to the second seal 248 and the first connector 204, and vice versa. The second seal 348 can be a rolling seal that can open and close. For example, the second seal 348 can be biased in a closed position. In the closed position, an inner end 356 of the second seal 348 can, when the downstream end 350 of the second connector is inserted in first connector 304, grip (e.g., apply pressure to) the downstream end 350 to seal downstream regions of the first connector 304 from debris or other contaminants generated upstream of the second seal 348. An outer end 358 of the second seal 348 can be manipulated (e.g., pressed downstream) to overcome the inward bias and to move the inner end 356 radially outward and open the second seal 348. Opening the second seal 348 can facilitate insertion and/or removal of the downstream end 350, and can reduce or eliminate abrasion since second seal 348 can allow the downstream end 350 to be inserted into the first connector 304 without contacting other parts of the first connector 304 besides the second seal 348. The first connector 304 can include a window 359 for accessing the outer end 358 of the second seal 348 to open and close the second seal 348.

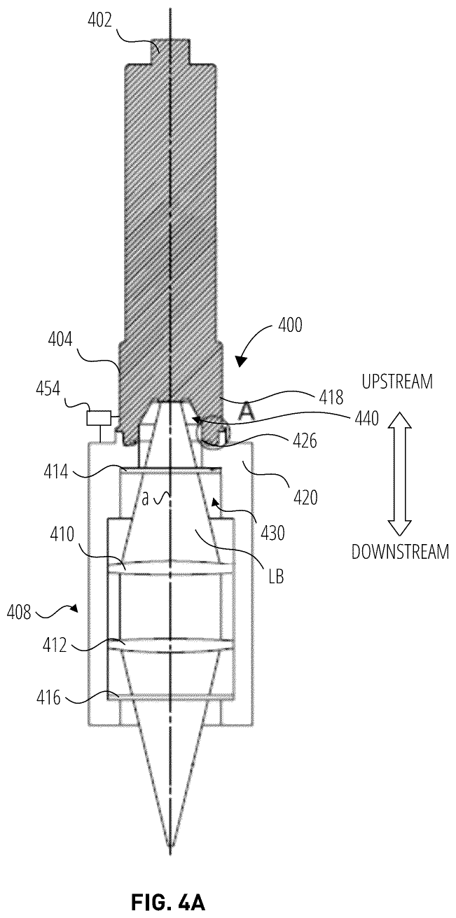

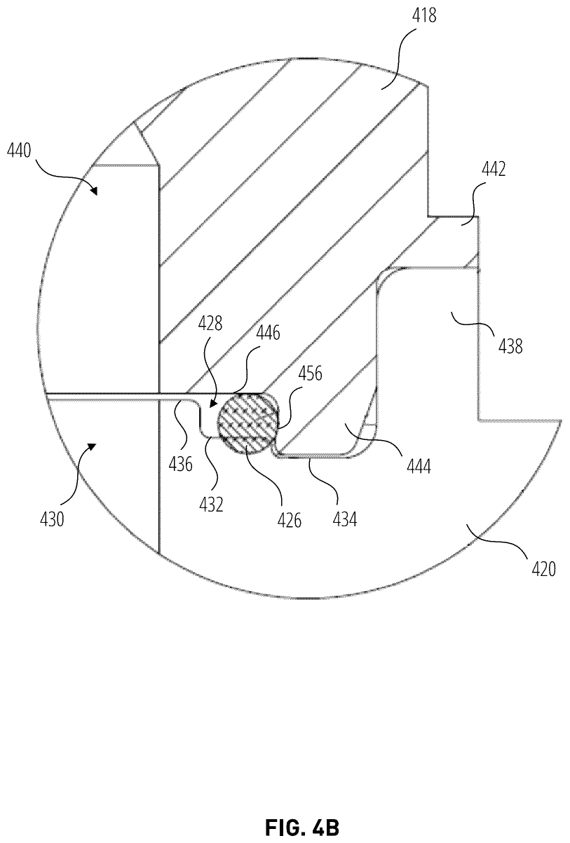

FIG. 4A shows a cross section schematic view of a system 400 for connecting a fiber optic cable 402 and focusing a laser beam LB received from the fiber optic cable 402 in accordance with some aspects of this disclosure.

FIG. 4B shows a magnified view of the system 400 within region A of FIG. 4A. The system 400 can include the features, structures, relationships, etc. described previously with respect to the system 200, and vice versa. For example, the system 400 can include the fiber optic cable 402, the connector 404 (which can include the features, structures, relationships, etc. described previously in reference to the first connector 204). The system 400 can further include the optics 408, which can include the first lens 410, the second lens 412, the upstream shield 414, the downstream shield 416, the upstream end 420, and the interior 430, described previously and having the same features as described with corresponding component of optics 208. As with the system 200, the upstream shield 414 and the downstream shield 416 are optional. The system 400 can include the seal 426 (which can include the features, structures, relationships, etc. described previously with respect to the first seal 226), which can sit within the recess 428. The upstream end 420 can include the first seat 432, the second seat 434, the inner face 436, and the flange 438, as described previously. The downstream end 418 of the connector 404 can define an interior 440. The downstream end 418 of the connector 404 can include the flange 442, the projection 444, the notch 456, and the inner face 446, as described previously. The system 400 can include the fastener 454, as described previously.

The system 400 can differ from the system 200 in that the connector 404 can be directly connected to the fiber optic cable 402, which obviates the second connector 206 and/or the laser receiver 106, described previously. Directly connecting the connector 404 to the fiber optic cable 402 without an intervening connector can be advantageous by eliminating sources of contact abrasion and/or fretting, simplifying the system 400, reducing costs, improving manufacturability, among other advantages.

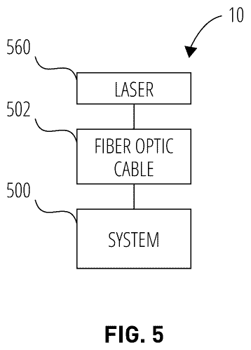

FIG. 5 shows a schematic view of a laser processing head 10 according to aspects of this disclosure. The laser processing head 10 can include a laser 560 that can generate the laser beam, described previously. The laser processing head 10 can include the fiber optic cable 502, described previously, which can be in optical communication with the laser 560. The laser processing head 10 can include a system 500, which can be connected to and in optical communication with the fiber optic cable 502. The system 500 can be the system 200 or the system 400, described previously.

It will be appreciated that the foregoing description provides examples of the invention. However, it is contemplated that other implementations of the invention may differ in detail from the foregoing examples. All references to the invention or examples thereof are intended to reference the particular example being discussed at that point and are not intended to imply any limitation as to the scope of the invention more generally. All language of distinction and disparagement with respect to certain features is intended to indicate a lack of preference for those features, but not to exclude such from the scope of the invention entirely unless otherwise indicated.

What is claimed is:

1. A system comprising:
optics configured to receive a laser beam,
a connector configured to connect to an upstream end of the optics and configured to optically communicate the laser beam from a fiber optic cable to the optics; and
a seal configured to sit within a recess between the upstream end of the optics and a downstream end of the connector,
wherein a portion of the connector and a portion of the optics are configured, when the connector is connected to the optics, to maintain separation between the connector and the optics radially inwardly of the seal.

2. The system of claim 1, wherein:
the optics define an interior, and
the portion of the connector and the portion of the optics are configured, when the connector is connected to the optics, to define a gap throughout a three dimensional region between the connector and the optics from the seal to the interior of the optics and to prevent any direct contact between the connector and the optics.

3. The system of claim 1, wherein the upstream end of the optics comprises a seat that the seal is configured to sit within.

4. The system of claim 3, wherein:
the downstream end of the connector comprises an inner face and a projection that projects downstream beyond the inner face, and
the recess is defined by the seat, the inner face, and the projection.

5. The system of claim 4, wherein:
the upstream end of the optics comprises an inner face,
the seat is recessed downstream from the inner face of the upstream end of the optics, and
the portion of the connector and the portion of the optics are configured, when the connector is connected to the optics, to prevent direct contact between the inner face of the connector and the inner face of the optics.

6. The system of claim 1, wherein:
the upstream end of the optics comprises a flange projecting upstream, and
the flange is configured, when the connector is connected to the optics, to align a center of an interior of the connector with a center of an interior of the optics.

7. The system of claim 6, wherein:
the downstream end of the connector comprises a flange projecting radially outwardly,
the portion of the optics comprises the flange of the upstream end of the optics,
the portion of the connector comprises the flange of the downstream end of the connector, and
the flange of the downstream end of the connector and the flange of the upstream end of the optics are configured, when the connector is connected to the optics, to abut against each other to maintain separation between the connector and the optics radially inwardly of the seal.

8. The system of claim 1, wherein:
the downstream end of the connector comprises a projection that projects downstream,
the upstream end of the optics comprises a seat, and
the seat is configured, when the connector is connected to the optics, to receive the projection.

9. The system of claim 8, wherein:
the portion of the optics comprises the seat,
the portion of the connector comprises the projection,
the projection and the seat are configured such that, when the connector is connected to the optics, the projection sits within the seat and maintains separation between the connector and the optics radially inwardly from the seal.

10. The system of claim 8, wherein:
the upstream end of the optics comprises a flange projecting upstream,
the downstream end of the connector comprises a flange projecting radially outwardly,
the portion of the optics further comprises the flange of the upstream end of the optics,
the portion of the connector further comprises the flange of the downstream end of the connector, and
the flange of the downstream end of the connector and the flange of the upstream end of the optics are configured, when the connector is connected to the optics, to abut against each other to maintain separation between the connector and the optics radially inwardly of the seal.

11. The system of claim 10, wherein the flange of the upstream end of the optics, the flange of the downstream end of the connector, the seat, and the projection are radially outward of the seal when the seal is within the recess.

12. The system of claim 1, wherein:
the connector is a first connector and the system further comprises a second connector,
the second connector is connected to the fiber optic cable, and
the first connector is configured to receive the second connector within an interior of the first connector.

13. The system of claim 12, wherein the seal is a first seal and the system further comprises a second seal within the interior of the first connector.

14. The system of claim 13, wherein:
an outer surface of the second connector is configured, when the second connector is received within the interior of the first connector, to directly contact an inner surface of the first connector to define an interface, and
the second seal is downstream from the interface.

15. The system of claim 14, wherein the second seal, when the first seal is within the recess, is upstream from the first seal.

16. The system of claim 1, wherein the connector is directly connected to the fiber optic cable.

17. A laser processing head comprising:
a laser configured to generate a laser beam;
a fiber optic cable in optical communication with the laser;
a connector in optical communication with the fiber optic cable;
optics in optical communication with the connector and connected to a downstream end of the connector, the optics being configured to receive the laser beam; and
a seal configured to sit within a recess between an upstream end of the optics and the downstream end of the connector,
wherein a portion of the connector and a portion of the optics are configured, when the connector is connected to the optics, to maintain separation between the connector and the optics radially inwardly of the seal.

18. The laser processing head of claim 17, wherein:
the optics define an interior, and
the portion of the connector and the portion of the optics are configured, when the connector is connected to the optics, to define a gap throughout a three dimensional region between the connector and the optics from the seal to the interior of the optics and to prevent any direct contact between the connector and the optics.

19. The laser processing head of claim 17, wherein:
the portion of the optics comprises a flange at the upstream end of the optics,
the portion of the connector comprises a flange at the downstream end of the connector, and
the flange of the downstream end of the connector and the flange of the upstream end of the optics are configured, when the connector is connected to the optics, to abut against each other to maintain separation between the connector and the optics radially inwardly of the seal.

20. The laser processing head of claim 17, wherein:
the portion of the connector comprises a projection at the downstream end of the connector,
the portion of the optics comprises a seat at the upstream end of the optics, and
the seat and the projection are configured, when the connector is connected to the optics, such that the projection sits within the seat and maintains separation between the connector and the optics radially inwardly from the seal.
